(19) United States
(12) Patent Application Publication
(10) Pub. No.: US 2010/0002447 A1
(43) Pub. Date: Jan. 7, 2010

(54) LIGHT-GUIDING ELEMENT, LIGHT-EMITTING MODULE, AND ELECTRONIC DEVICE

(76) Inventors: Yu-Te Lin, Taipei (TW); Yi-Lung Lin, Taipei (TW); Chao-Yang Hsu, Taipei (TW)

Correspondence Address: Muncy, Geissler, Olds & Lowe, PLLC, P.O. BOX 1364, FAIRFAX, VA, 22038-1364, US

(21) Appl. No.: 12/494,938

(22) Filed: Jun. 30, 2009

(30) Foreign Application Priority Data
Jul. 1, 2008 (TW) 097124727

(51) Int. Cl. F21V 7/00

(52) U.S. Cl. 362/296.01

(57) ABSTRACT

A light-guiding element cooperates with a light source and includes a light-guiding frame and a scattering material. The light-guiding frame has a light incident surface, a light output surface, and an inclined surface. Light emitted by the light source enters into the light-guiding frame through the light incident surface, and the light is reflected by the inclined surface to be outputted through the light output surface. The scattering material is disposed at the inclined surface. A light-emitting module having the light-guiding element and an electronic device are also disclosed.

### CROSS REFERENCE TO RELATED APPLICATIONS

This Non-provisional application claims priority under 35 U.S.C. §119(a) on Patent Application No(s). 097124727 filed in Taiwan, Republic of China on Jul. 1, 2008, the entire contents of which are hereby incorporated by reference.

### BACKGROUND OF THE INVENTION

1. Field of Invention

The invention relates to a light-guiding element and, more particularly, to a light-emitting module having a light-guiding element and an electronic device having the same.

2. Related Art

With the development of the science technology, the needs of electronic devices become higher. For example, a light-emitting module may be disposed at an edge of a touch pad of a notebook computer, and it may light facilitating use in the dark. The light-emitting module mainly has a light source and a light-guiding frame. The light emitted by the light source enters into the light-guiding frame, and a circular light output surface formed by the light-guiding frame is located at the edge of the touch pad.

To obtain uniform output light, in a conventional light-emitting module, light-scattering agents are fed into a mold to form a light-guiding frame having the light-scattering agents via injection molding. However, at present, no software can be provided for users to simulate the light-scattering agents. Therefore, the light-scattering agents in different proportions need to be trialed in manufacturing the light-guiding frame thus to obtain a best proportion, which greatly increases cost. Further, the light-scattering agents may greatly absorb the light in the light-guiding frame, thus to reduce the output light.

In addition, a conventional method to obtain uniform output light is mold texturing. That is, mold texture is made on the light-guiding frame. However, the present mold texturing fails to completely atomize the light output surface. That is, the users can still see the internal structure of the light-guiding frame indistinctly, and they may feel that the uniformity is not better. In addition, the mold texturing is also easy to cause mold drawing, thereby decreasing the lifespan of the mold.

### SUMMARY OF THE INVENTION

This invention provides a light-guiding element, a light-emitting module, and an electronic device obtaining uniform output light.

The invention provides a light-guiding element, a light-emitting module, and an electronic device. Thereby, cost is reduced. Further, light is avoided being absorbed and the mold is avoided being damaged.

According to one aspect of the invention, the light-guiding element cooperates with a light source and includes a light-guiding frame and a scattering material. The light-guiding frame has a light incident surface, a light output surface, and an inclined surface. Light emitted by the light source enters into the light-guiding frame through the light incident surface, and the light is reflected by the inclined surface to be outputted through the light output surface. The scattering material is disposed at the inclined surface.

According to another aspect of the invention, the light-emitting module includes a light source and a light-guiding element. The light-guiding element includes a light-guiding frame and a scattering material. The light-guiding frame has a light incident surface, a light output surface, and an inclined surface. Light emitted by the light source enters into the light-guiding frame through the light incident surface, and the light is reflected by the inclined surface to be outputted through the light output surface. The scattering material is disposed at the inclined surface.

According to the third aspect of the invention, the electronic device includes a component and a light-emitting module. The component covers a part of the light-emitting module. The light-emitting module includes a light source and a light-guiding element. The light-guiding element includes a light-guiding frame and a scattering material. The light-guiding frame has a light incident surface, a light output surface, and an inclined surface. Light emitted by the light source enters into the light-guiding frame through the light incident surface, and the light is reflected by the inclined surface to be outputted through the light output surface. The scattering material is disposed at the inclined surface.

According to the above, in the invention, an inclined surface is disposed at a place corresponding to the light output surface, and the scattering material is disposed at the inclined surface. Therefore, the light entering into the light incident surface is reflected to the light output surface by the inclined surface and is scattered by the scattering material to uniform the output light through the light output surface.

These and other features, aspects, and advantages of the present invention will become better understood with regard to the following description, appended claims, and accompanying drawings.

### BRIEF DESCRIPTION OF THE DRAWINGS

The invention will become more fully understood from the detailed description and accompanying drawings, which are given for illustration only, and thus are not limitative of the present invention, and wherein:

FIG. 1 and FIG. 2 are schematic diagrams showing a light-emitting module from different views according to a preferred embodiment of the invention;

FIG. 3 is a partial sectional schematic diagram showing a light-emitting module according to a preferred embodiment of the invention;

FIG. 4 is a partial sectional schematic diagram showing a light-emitting module according to another preferred embodiment of the invention; and

FIG. 5 is a schematic diagram showing an electronic device according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

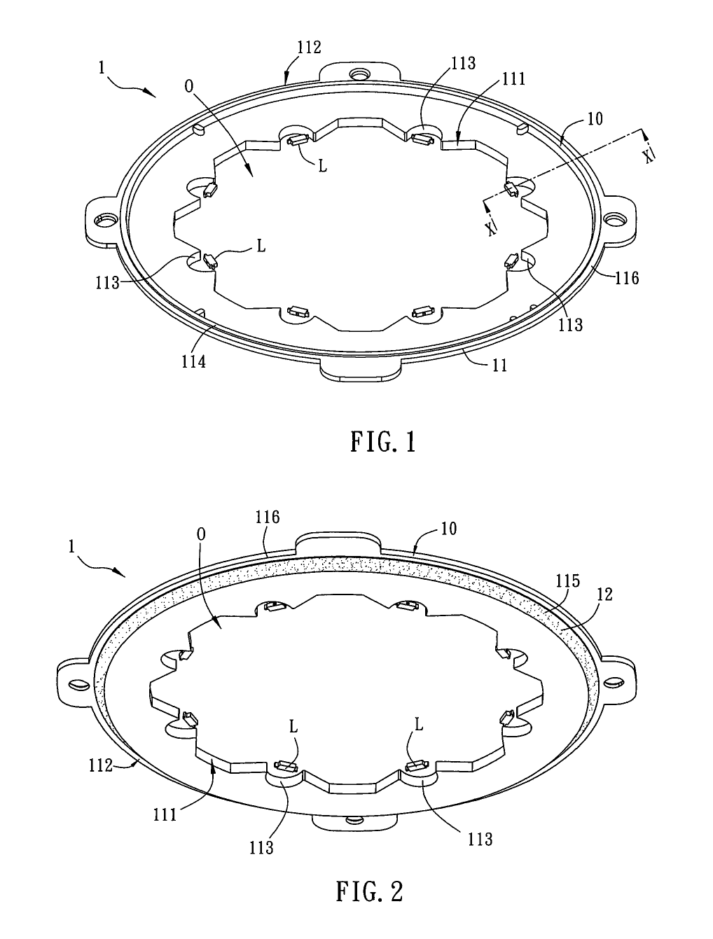

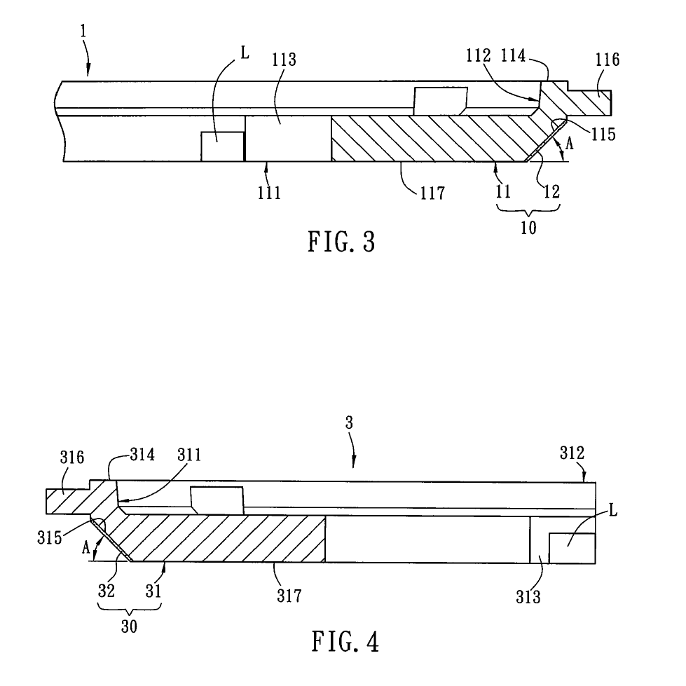

FIG. 1 and FIG. 2 are schematic diagrams showing a light-emitting module from different views according to a preferred embodiment of the invention. FIG. 3 is a partial sectional diagram showing the light-emitting module in FIG. 1 along a sectional line X-X. Please refer to FIGS. 1-3. In the embodiment, the light-emitting module 1 includes a light source L and a light-guiding element 10. In the embodiment, a plurality of light sources L are taken for example.

The light-guiding element 10 includes a light-guiding frame 11 and a scattering material 12. The light-guiding frame 11 has a light incident surface 113, a light output surface 114, and an inclined surface 115. The scattering material 12 is disposed at the inclined surface 115. Light emitted by the light sources L enters into the light-guiding frame 11 through the light incident surface 113, and the light is reflected by the inclined surface 115 to be outputted through the light output surface 114. Since the scattering material 12 is disposed at the inclined surface 115, the light is scattered when passing through the inclined surface 115, thus uniforming the output light through the light output surface 114.

The light-guiding element 10 is described hereinbelow in detail. In the embodiment, the light-guiding frame 11 further has an inner rim 111 and an outer rim 112. The inner rim 111 forms a hollow portion O which can be a through hole or an opening. In the embodiment, the hollow portion O is a through hole. The light incident surface 113 is located at the inner rim 111. The light output surface 114 and the inclined surface 115 are located at the outer rim 112, and they are opposite to each other.

In the embodiment, the scattering material 12 may include printing ink or other scattering materials. The scattering material may include polymethyl methacrylate (PMMA) or polystyrene (PS). The scattering material 12 can be white, thereby improving the scattering effect. The scattering material 12 can be disposed at the inclined surface 115 by spraying, spreading, or printing. The scattering material 12 can be disposed at the inclined surface 115 continuously or discontinuously. For example, the density of the scattering material 12 at the area having stronger light may be greater than that of the scattering material 12 at the area having weaker light, thus to uniform the output light. In addition, the light-guiding frame 11 in the embodiment further has a stopping portion 116 protruding between the light output surface 114 and the inclined surface 115. In the embodiment, the stopping portion 116 is protrudent from the outer rim 112. The stopping portion 116 can prevent the scattering material 12 from overflowing the light output surface 114 in forming the scattering material 12.

In the embodiment, the inclined surface 115 and a bottom surface 117 of the light-guiding frame 11 form an angle A. In the embodiment, the angle A is 45 degrees, thereby achieving a better reflection effect. In other embodiments, the angle A may be designed according to the relative positions between the light incident surface 113 and the light output surface 114.

In addition, the light source L in the embodiment is a light-emitting diode (LED). The light source L may be other light sources such as an organic LED, a cold-cathode tube and so on. The light source L is opposite to the light incident surface 113, thereby achieving a better light incident effect. The light incident surface 113 can be curved, and a curve of the light incident surface 113 can correspond to a distribution of light intensity or a light-emitting angle of the light source L.

In addition, in the embodiment, the closed light-guiding frame 11 is taken for example, and the light output surface 114 is a closed ring. In other embodiments, the light-guiding frame 11 may be broken. That is, it may not be closed. At that moment, the light output surface is an open ring such as a C-shaped ring. In addition, in other embodiments, with the change of the shapes of the light-guiding frame 11, the light output surface 114 may also be different. The light output surface 114 may be a triangular ring, a quadrate ring, or a polygonal ring and so on.

FIG. 4 is a partial sectional schematic diagram showing a light-emitting module 3 according to another preferred embodiment of the invention. Please refer to FIG. 4. The light-emitting module 3 includes at least one light source L and a light-guiding element 30. The light-guiding element 30 has a light-guiding frame 31 and a scattering material 32. The light-guiding frame 31 has an inner rim 311, an outer rim 312, a light incident surface 313, a light output surface 314, an inclined surface 315, a stopping portion 316, and a bottom surface 317. Since the features of the scattering material 32 and the inclined surface 315 in this embodiment are the same as that of the scattering material 12 and the inclined surface 115 in the above embodiment. Therefore, they are not described for a concise purpose.

The main difference between the light-emitting module 3 and the light-emitting module 1 is that the light-guiding frame 31 is curved. That is, the light-guiding frame 31 is not closed. The light incident surface 313 is located at the outer rim 312, and the light output surface 314 and the inclined surface 315 are located at the inner rim 311. Thus, the light emitted by the light source L enters into the light-guiding frame 31 through the light incident surface 313, and the light is reflected to the light output surface 314 by the inclined surface 315. Further, the light is scattered by the scattering material 32, thus uniforming the output light through the light output surface 314. In the embodiment, the light output surface 314 is curved, and the length of the curve is smaller than that of the curve of the outer rim 312.

In addition, the stopping portion 316 is protrudent from the inner rim 311 and is between the light output surface 314 and the inclined surface 315. The stopping portion 316 can prevent the scattering material 32 from overflowing the light output surface 314 in forming the scattering material 32.

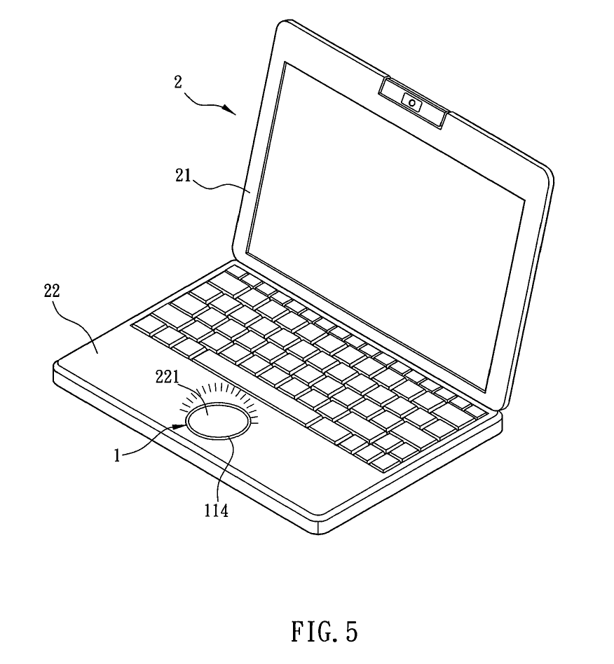

FIG. 5 is a schematic diagram showing an electronic device 2 having a light-emitting module 1 according to a preferred embodiment of the invention. In the embodiment, the light-emitting module 1 is taken for example. In other embodiments, the electronic device 2 may also have the light-emitting module 3. The electronic device 2 may be a flat display device, a mobile communication device, or a computer. In the embodiment, a notebook computer is taken for example.

The electronic device 2 includes a display portion 21 and a main body portion 22. The display portion 21 and the main body portion 22 are electrically connected to each other. The display portion 21 is used for display, and the main body portion 22 is used for operation. The main body portion 22 has a component 221. In the embodiment, the component 221 is a touch pad. The component 221 covers a part of the light-emitting module 1. In the embodiment, the component 221 covers the hollow portion O of the light-emitting module 1 and exposes the light output surface 114. Thereby, the light outputted through the light output surface 114 can be seen. Thus, the uniform circular output light is formed around the component 221.

To sum up, in the invention, an inclined surface is disposed at a place corresponding to the light output surface, and the scattering material is disposed at the inclined surface. Therefore, the light entering into the light incident surface is reflected to the light output surface by the inclined surface and is scattered by the scattering material to uniform the output light through the light output surface. Further, the uniform output light can be obtained without light-scattering agents and mold texturing, thus reducing cost and avoiding absorbing the light and damaging the mold.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A light-guiding element cooperating with a light source, comprising:
a light-guiding frame having a light incident surface, a light output surface, and an inclined surface, light emitted by the light source entering into the light-guiding frame through the light incident surface and being reflected by the inclined surface to be outputted through the light output surface; and
a scattering material disposed at the inclined surface.

2. The light-guiding element according to claim 1, wherein the scattering material comprises printing ink.

3. The light-guiding element according to claim 1, wherein the scattering material is white.

4. The light-guiding element according to claim 1, wherein the scattering material is disposed at the inclined surface by spraying, spreading, or printing.

5. The light-guiding element according to claim 1, wherein the scattering material is disposed at the inclined surface continuously or discontinuously.

6. The light-guiding element according to claim 1, wherein the inclined surface and a bottom surface of the light-guiding frame form an angle of 45 degrees.

7. The light-guiding element according to claim 1, wherein the light-guiding frame further has a stopping portion protruding between the light output surface and the inclined surface.

8. The light-guiding element according to claim 1, wherein the light output surface is circular.

9. The light-guiding element according to claim 1, wherein the light incident surface is curved.

10. The light-guiding element according to claim 9, wherein a curve of the light incident surface corresponds to a distribution of light intensity or a light-emitting angle of the light source.

11. The light-guiding element according to claim 1, wherein the light-guiding frame further has an inner rim and an outer rim.

12. The light-guiding element according to claim 11, wherein the inner rim forms a hollow portion.

13. The light-guiding element according to claim 11, wherein the light incident surface is located at the inner rim, and the light output surface and the inclined surface are located at the outer rim.

14. The light-guiding element according to claim 11, wherein the light incident surface is located at the outer rim, and the light output surface and the inclined surface are located at the inner rim.

15. A light-emitting module comprising:
a light source; and
a light-guiding element including:
a light-guiding frame having a light incident surface, a light output surface, and an inclined surface, light emitted by the light source entering into the light-guiding frame through the light incident surface and being reflected by the inclined surface to be outputted through the light output surface; and
a scattering material disposed at the inclined surface.

16. The light-emitting module according to claim 15, wherein the light source is a light-emitting diode.

17. An electronic device comprising:
a component; and
a light-emitting module, the component covering a part of the light-emitting module, the light-emitting module including:
a light source; and
a light-guiding element including:
a light-guiding frame having a light incident surface, a light output surface, and an inclined surface, light emitted by the light source entering into the light-guiding frame through the light incident surface and being reflected by the inclined surface to be outputted through the light output surface; and
a scattering material disposed at the inclined surface.

18. The electronic device according to claim 17, wherein the scattering material comprises printing ink.

19. The electronic device according to claim 17, wherein the scattering material is white.

20. The electronic device according to claim 17, wherein the scattering material is disposed at the inclined surface by spraying, spreading, or printing.

21. The electronic device according to claim 17, wherein the scattering material is disposed at the inclined surface continuously or discontinuously.

22. The electronic device according to claim 17, wherein the inclined surface and a bottom surface of the light-guiding frame form an angle of 45 degrees.

23. The electronic device according to claim 17, wherein the light-guiding frame further has a stopping portion protruding between the light output surface and the inclined surface.

24. The electronic device according to claim 17, wherein the light output surface is circular.

25. The electronic device according to claim 17, wherein the light incident surface is curved.

26. The electronic device according to claim 25, wherein a curve of the light incident surface corresponds to a distribution of light intensity or a light-emitting angle of the light source.

27. The electronic device according to claim 17, wherein the light-guiding frame further has an inner rim and an outer rim.

28. The electronic device according to claim 27, wherein the inner rim forms a hollow portion.

29. The electronic device according to claim 27, wherein the light incident surface is located at the inner rim, and the light output surface and the inclined surface are located at the outer rim.

30. The electronic device according to claim 27, wherein the light incident surface is located at the outer rim, and the light output surface and the inclined surface are located at the inner rim.

31. The electronic device according to claim 17, wherein the light source is a light-emitting diode.

32. The electronic device according to claim 17, wherein the component is a touch pad.
